(19) United States
(12) Patent Application Publication
(10) Pub. No.: US 2012/0169745 A1
(43) Pub. Date: Jul. 5, 2012

(54) Method and System for Selecting Data for Display in a Plurality of Displays

(76) Inventors: Collis Quinn Carter, Richmond Hill (CA); Gabriel Abarca, Richmond Hill (CA); Jie Zhou, Richmond Hill (CA)

(21) Appl. No.: 13/324,837

(22) Filed: Dec. 13, 2011

Related U.S. Application Data
(60) Provisional application No. 61/422,516, filed on Dec. 13, 2010.

(51) Int. Cl. G06F 13/14; G09G 5/00

(52) U.S. Cl. 345/520; 345/204

(57) ABSTRACT

Systems, methods, and computer readable storage mediums for arbitrating the sending of display data to a plurality of displays that are coupled to a controller are disclosed. A method for arbitrating display data requests for a plurality of displays coupled to a controller includes, providing display data to a display in the plurality of displays based upon a relative priority of the display amongst the plurality of displays.

### CROSS REFERENCE TO RELATED APPLICATIONS

This application claims the benefit of U.S. provisional application No. 61/422,516, filed on Dec. 13, 2010, which is hereby incorporated by reference in its entirety.

### BACKGROUND OF THE INVENTION

1. Field of the Invention

The present invention relates generally to displaying of video in multiple displays.

2. Background Art

A variety of displays, such as digital monitors, liquid crystal display (LCD) televisions, and the like, are increasingly available at affordable costs. Also, frequently a single computer, or other image source, can be connected to more than one display. For example, a personal computer can be connected to two or more monitors, a video source such as a digital video disk player can be connected to two or more LCD televisions, or a set-top box can be connected to two television screens. In each case, the same or different video content may be displayed on each of these multiple displays.

Frequently two or more of the displays connected to the same computer have different display characteristics. For example, the display clock based on which pixels are displayed on each of the displays can be different. A 640×480 and a 1600×1200 resolution monitors connected to the same computer is an environment in which the same computer has to substantially simultaneously provide display data to displays having different display clocks. A graphics controller inside the computer may be coupled, directly or indirectly, to one or more video sources and would be required to send video data to the multiple displays so that each display can operate smoothly.

In conventional systems, the graphics controller distributes incoming video data to the plurality of displays based upon predetermined criteria such as the display resolution of the respective display, the respective display clocks, or a round robin scheme. However, such methods can often lead to display artifacts due to one or more of the displays either not having data to display or too much display data being sent to that device that its internal buffers cannot accommodate the data received from the graphics controller.

Therefore, what are needed are methods and systems for improving the transmission of video data from a graphics controller to a plurality of displays.

### BRIEF SUMMARY OF EMBODIMENTS OF THE INVENTION

Systems, methods, and computer readable storage mediuma for arbitrating the sending of display data to a plurality of displays that are coupled, or for coupling, to a controller are disclosed. Arbitration is performed according to a relative priority determined based upon when data is needed to be displayed by each of the coupled displays. According to an embodiment, a method for arbitrating display data requests for a plurality of displays that are configured for coupling to a controller includes, providing display data to a display in the plurality of displays based upon a relative priority of the display amongst the plurality of displays.

According to another embodiment, a graphics controller includes a plurality of display interfaces respectively configured to couple one or more of a plurality of displays, and a display output arbitration module coupled to the one or more display interfaces. The display output arbitration module is configured for providing display data to a display in the plurality of displays based upon a relative priority of the display amongst the plurality of displays.

Another embodiment is a computer readable medium storing instructions wherein the instructions when executed are adapted to arbitrate display data requests for a plurality of displays coupled to a controller by providing display data to a display in the plurality of displays based upon a relative priority of the display amongst the plurality of displays.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated in and constitute part of the specification, illustrate embodiments of the invention and, together with the general description given above and the detailed description of the embodiment given below, serve to explain the principles of the present invention. In the drawings:

FIG. 1 shows a system, according to an embodiment of the present invention.

FIG. 2 is a graphics controller for arbitrating display data requests for a plurality of displays, according to an embodiment of the present invention.

FIG. 3 is a flowchart illustrating a method for arbitrating display data requests for a plurality of displays coupled to a controller, according to an embodiment of the present invention.

FIG. 4 is a flowchart illustrating a method for determining a relative priority ordering of the displays, according to an embodiment of the present invention.

FIG. 5 is a flowchart illustrating a method to determine a next time interval for a display to receive display data, according to an embodiment of the present invention.

### DETAILED DESCRIPTION OF EMBODIMENTS OF THE INVENTION

Embodiment of the present invention can substantially improve the performance of systems where video is displayed simultaneously in multiple displays. While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Embodiments of the present invention may be used in any system with multiple displays including, but not limited to, a computer system or computing device and/or a graphics controller that can interface to a plurality of displays. For example and without limitation, embodiments may include computers including laptop computers, personal computers, or any other computer with a display terminal, game platforms, set-top boxes, entertainment platforms, personal digital assistants, and video platforms including, such as, flat-panel television displays.

Embodiments of the present invention dynamically determine a priority ordering of the multiple displays connected to a graphics controller so that video data can be sent to the respective displays. The ordering is based upon the need for display data at each display so that the performance of the entire system is improved. In embodiments of the present invention, the display characteristics, including real-time or near real-time characteristics of each display, are considered in determining when that device would need more display data for displaying in the device. Each display is provided with display data in relation to the other displays connected to the graphics controller based upon when the display would need more display data.

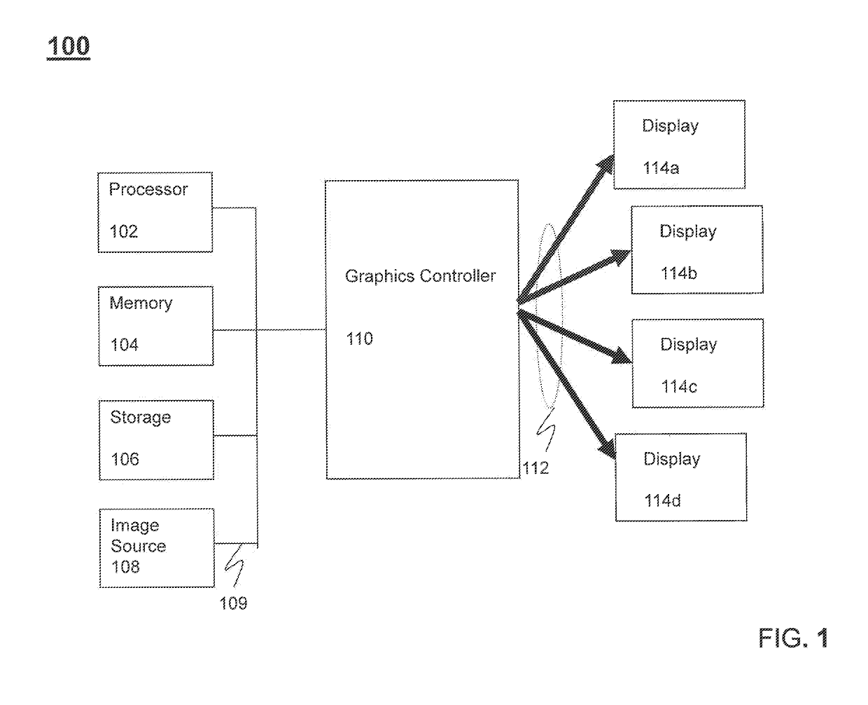

FIG. 1 is a system according to an embodiment of the present invention. System 100 can be a system for displaying video content in multiple displays using a single graphics controller. System 100 includes a processor 102, a memory 104, a persistent storage 106, an image source 108, a communication infrastructure 109, a graphics controller 110, interfaces 112 to a plurality of displays, and displays 114a-114d. Processor 102 can be one or more central processor units (CPUs) or other processor and controls the operation of the system 100. Memory 104 includes a dynamic memory such as dynamic random access memory (DRAM) for storing data and instructions during the operation of the system.

Persistent storage 106 includes a persistent digital data storage medium such as a hard disk, optical disc, or flash memory. Persistent storage device 106 can be used, for example, to store data such as video data and instructions persistently. Communication infrastructure 109 can include one or more communication busses, such as, but not limited to, a Peripheral Component Interface (PCI) bus, PCI express bus, or Advanced Microcontroller Bus Architecture (AMBA) bus. According to an embodiment, communication infrastructure 109 can communicatively couple the various components of system 100.

Image source 108 includes one or more image sources that generate content for display in the displays 114a-114d. According to an embodiment, image source 108 can include a DVD player, a set-top box, or other video content generator. Image source 108 can also include one or more interfaces communicatively coupling system 100 to remote video content generators or image sources. For example, image source 108 can include a network interface over which streaming video content is received from a network such as the Internet.

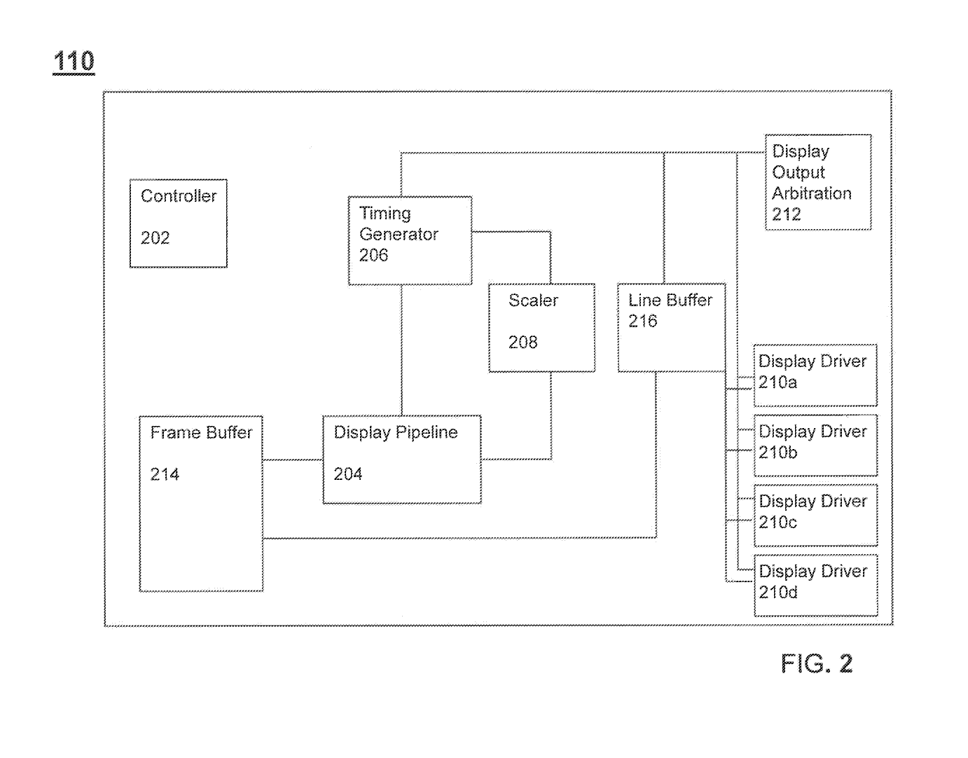

Graphics controller 110 may be coupled to numerous other hardware or software components in, for example, a computer system. Graphics controller 110 may be a dedicated graphics card that plugs into the motherboard of a computer system, a part of another component card that plugs into the motherboard, or an integrated part of the motherboard. For example, graphics controller 110 may plug into a Peripheral Component Interface (PCI) bus through which the CPU of the computer system connects to other components of the computer system. Further details of graphics controller 110 are described below with respect to FIG. 2.

Displays 114a-114d can include any kind of display capable of displaying content received from system 100. Displays 114a-114d can be any display or screen such as a cathode ray tube (CRT) or a flat panel display. Flat panel displays come in many forms, LCD, electroluminescent displays (ELD) and active-matrix thin-film transistor displays (TFT) being examples. Respective displays 114a-114d may receive data to be displayed, locations on the display to be updated, as well as any timing information, over interfaces 112. Interfaces 112 can include a plurality of interfaces that couple the graphics controller 110 to the respective displays 114a-114d. Interfaces 112 may support one or more of interface standards, such as, but not limited to, DisplayPort interface standard, High Definition Multimedia Interface (HDMI) standard, Digital Visual Interface (DVI), Video Graphics Array (VGA) or its variants, and Low Voltage Differential Signaling (LVDS).

Data and control information is transferred over interfaces 112 to respective displays 114a-114d. The data transmitted over interfaces 112 can include pixel data, such as, red green blue (RGB) color sample data for each pixel. Control information transmitted over interfaces 112 can include timing synchronization signals such as, for example, horizontal sync signals, vertical sync signals, and data enable signals to synchronize the respective displays with system 100.

FIG. 2 shows graphics controller 110, according to an embodiment of the present invention. Graphics controller 110 includes a controller 202, a display pipeline 204, a timing controller 206, a scaler 208, an output arbitration control module 212, a frame buffer 214, a line buffer 216, and display drivers 210a-210d. Controller 202 may be any processor including a CPU or graphics processor unit (GPU). Controller 202 controls the operation of graphics controller 110.

For example, controller 202 can execute the logic instructions implementing one or more of, display pipeline 204, scaler 208, timing controller 206, output arbitration control module 212, and display drivers 210a-210d. In other embodiments, there may not be a separate controller 202 present in graphics controller 110, and graphics controller 110 may be controlled by a CPU that controls one or more components of a computer system including graphics controller 110. The logic instructions of 204, 206, 208, and 210a-210d can be implemented in software, hardware, or a combination thereof.

For example, in one embodiment, logic instructions of one or more of 204, 206, 208, and 210a-210d can be specified in a programming language such as C, C++, or Assembly. In another embodiment, logic instructions of one or more of 204, 206, 208, and 210a-210d can be specified in a hardware description language such as Verilog, RTL, and netlists, to enable ultimately configuring a manufacturing process through the generation of maskworks/photomasks to generate a hardware device embodying aspects of the invention described herein.

Frame buffer 214 includes one or more memory devices, for example, such as DRAM devices. Frame buffer 214 is used to hold video data in memory while processing including the processing in display pipeline 204 and scaler 208 is in progress. Frame buffer 214 or other memory devices (not shown) are used for holding the video data, before and after the encoding of the video data into video frames, until the respective frames are transmitted to line buffer 216 and/or out of display drivers 210a-210d. Frame buffer 214 may hold any data that is actually output to displays 114a-114d. According to an embodiment, frame buffer 214 can include a plurality of physically or logically partitioned memories, where each display driver 210a-210d is associated with a respective one of the partitioned frame buffers.

Line buffer 216 can include one or more memories, such as DRAM memories, to hold one or more lines of display data for respective one of the displays 114a-114d. In some embodiments of the present invention, graphics controller 110 may not include a separate line buffer 216 and display data may be sent to respective display drivers 210a-210d directly from frame buffer 214. According to another embodiment, line buffer 216 can include a plurality of physically or logically partitioned memories, where each display driver 210a-210d is associated with a respective one of the partitioned line buffers.

Display pipeline 204 includes the functionality to process video data content. For example, incoming video in MPEG2 format may be decoded, reformatted, and reframed as appropriate for local raster scan display in display pipeline 204. Display pipeline 204 may generate a stream of video frames as output. For example, the pixel data to be displayed can be output from display pipeline 204 in the form of a raster scan, i.e., output line-by-line, left-to-right and top-to-bottom of the display. The stream of video frames may then run through an encoder (not shown).

The encoder may encode the stream of video frames according to a predetermined encoding and/or compression standard. For example, the encoder may encode the stream of data output from display pipeline in a transport and display format required by the respective interface 112 and/or display 114a-114d. The encoder may encode the data according to a customized format or according to a standard such as DisplayPort, embedded DisplayPort, DVI, LVDS, or HDMI.

Timing controller 206 receives the video frames output from the display pipeline 204 and/or associated encoder. Control information received from the display pipeline and/or encoder may include framing information, such as, frame interval, frame length, etc. Timing controller 206 generates timing including either a preconfigured or dynamically configurable interframe interval. For example, timing controller 206 may ensure that the interframe interval between any two video frames in the stream of frames transmitted out of timing controller 206 is constant. Timing controller 206 may also generate control signals including horizontal sync and vertical sync signals for each frame. According to an embodiment, timing controller 206 can generate the request for additional display data for respective displays.

Scaler 208, according to an embodiment, includes the functionality to perform scaling and/or descaling of the image to be displayed. For example, the display frame formed by display pipeline 204 may require to be scaled according to the display size or other properties of the respective display on which the image is to be displayed. According to an embodiment, the scaler 208 determines the corresponding source pixel position for a particular display pixel, for example, as indicated by the timing controller 206.

Display output arbitration module 212 includes the functionality to arbitrate between a plurality of displays that are coupled to the graphics controller 110. The arbitration can determine, during any iteration and/or clock cycle, which of the displays are to receive display content. Method 300, for example, can be implemented by display output arbitration module 212 to select, during each iteration, which displays are to receive display data from the frame buffer 214. In one illustrative embodiment, based on the arbitration, pixels from the frame buffer can be input to one or more line buffers associated with selected displays. According to another embodiment, based on the arbitration, display data is received at respective display drivers 210a-210d from the frame buffer 214, without an intervening line buffer.

Display drivers 210a-210d include functionality to transmit frames over respective interfaces 112 to the associated displays 114a-114d. Display drivers 210a-210d also include the functionality to transmit control signals over interfaces 112.

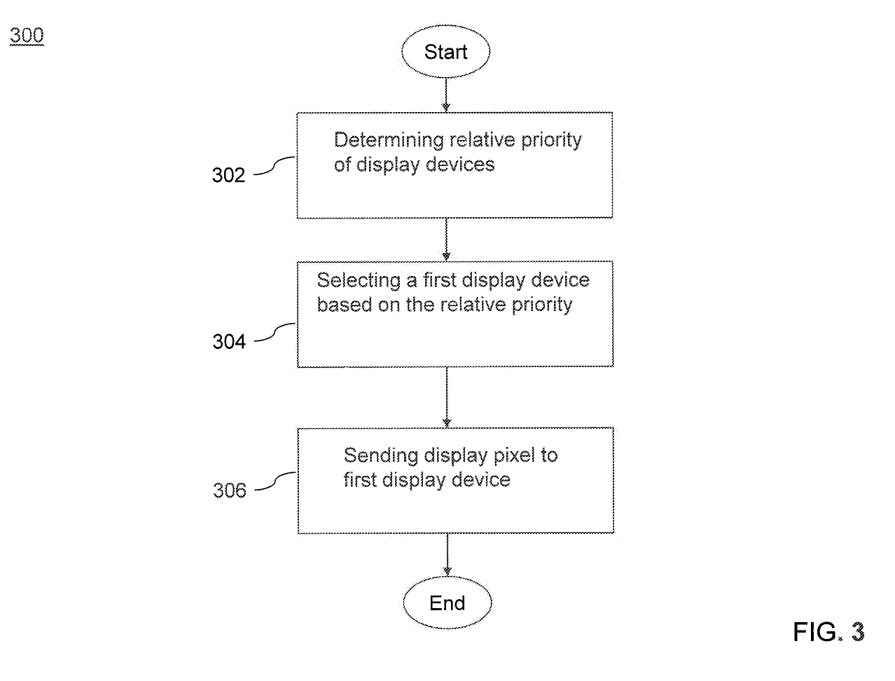

FIG. 3 is a flowchart illustrating an exemplary method of arbitrating between a plurality of displays that are coupled to a graphics controller, according to an embodiment of the present invention. Method 300 can be used, for example, to send video from one or more incoming video streams to a plurality of displays. Method 300 improves performance in sending display data to multiple displays by dynamically selecting between the respective displays for purposes of sending display data.

By way of example, method 300 can be iteratively performed, at intervals of one or more clock cycles, during the operation of a system to send video display data to two or more displays. Method 300 can be invoked, for example, due to receiving one or more requests for display data. The requests for display data can be originated from one or more of the displays, from the display drivers, or from the timing controller.

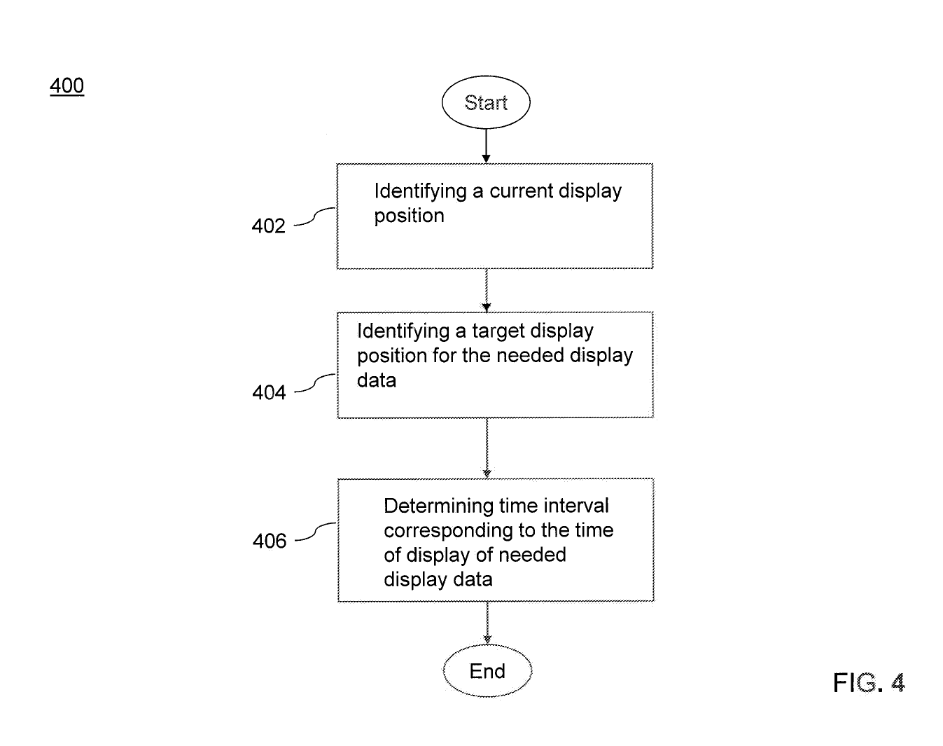

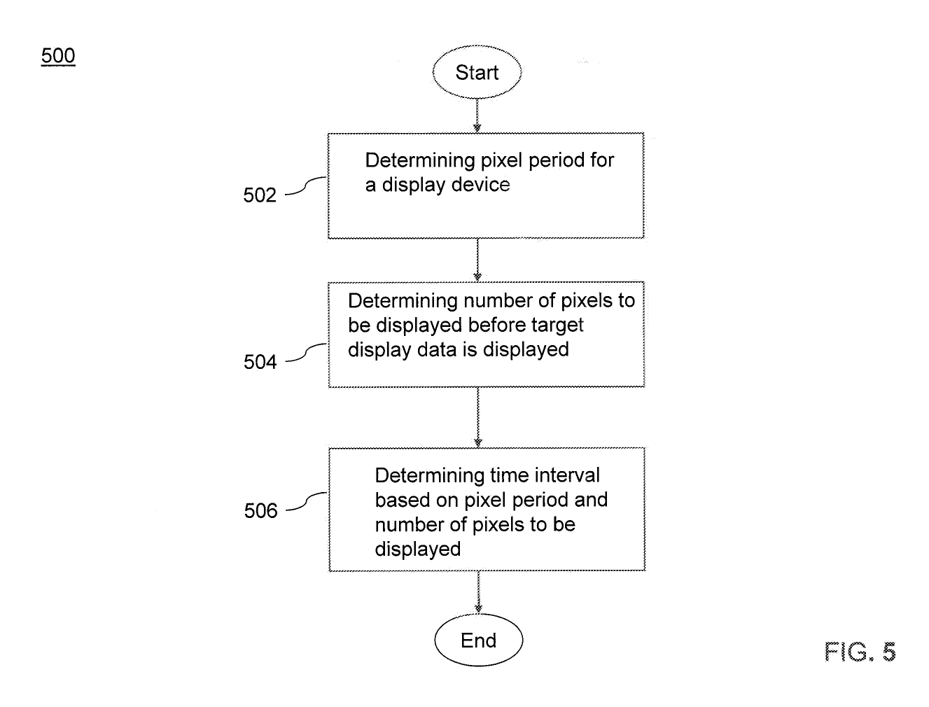

In step 302, a relative priority of each display is determined. According to an embodiment, a relative priority ordering of displays that are connected to a graphics controller through one or more interfaces is determined. The relative priority of a display can correspond to the length of the time interval after which it will need more data to be sent by the graphics controller. If, for example, a first display requires display data from the graphics controller after a shorter duration than a second display, then the first display has a higher priority relative to the second display. The determination of the relative priority ordering is further described below in relation to FIGS. 4 and 5.

In step 304, one or more of the displays is selected for receiving display data to be displayed. In each iteration of method 300, one display is selected to receive additional display data from the graphics controller. The selected display can be, for example, the display with the highest relative priority. By way of example, the relative priority ordering can be dynamically determined. In another example, if the graphics controller includes the required capabilities to substantially concurrently provide display data to more than one display, two or more displays can be selected for receiving display data. The two or more selected displays can include a predetermined number of devices that have the highest relative priorities in the iteration of method 300.

In step 306, display data is sent to the one or more selected displays. Display data is sent to the selected display determined to have the highest relative priority. According to another embodiment, display data is sent to the two or more selected displays that were selected based on the respective relative priorities. The sending of display data to a selected display can comprise the graphics controller transferring one or more pixels from a frame buffer to a line buffer associated with the selected display.

The graphics controller can input display data to a line buffer associated with the selected display. A display driver associated with the selected display extracts the display data from the line buffer and transmits that data to the display over an interface that couples the graphics controller and display. The graphics controller can transfer, or facilitate the transfer, of one or more pixels from a frame buffer memory directly to the display driver associated with the selected display. The display driver can be configured to transmit the display data to the associated display over the corresponding interface according to a predetermined interface standard. In one embodiment, the display driver extracts display data from a corresponding line buffer to be transmitted to the selected display. In another embodiment, for example, the display driver extracts the data from a corresponding frame buffer to be transmitted to the selected display.

FIG. 4 is a flowchart illustrating a method for determining a relative ordering of the displays, according to an embodiment of the present invention, According to an embodiment, step 302 of method 300 can be performed using method 400. During each iteration of method 300, method 400 can be performed for each display connected to the graphics controller. Method 400 can be implemented, for example, in a graphics controller, such as, graphics controller 110.

In step 402, the current display position of the display is determined. The current display position represents the position of the latest pixel displayed by the display. The position of the pixel can be represented as a coordinate in a two-dimensional place corresponding to the display area of the display. The current display position is represented as the tuple (x_{curr}, y_{curr}) where x_{curr} represents the displacement of the latest displayed pixel in a horizontal direction from a predetermined origin (e.g., the top left hand corner of the display area), and y_{curr} represents the latest displayed pixel in a vertical displacement from the origin.

In step 404, a target display position is determined for the display. The target display position can represent the position of the first yet to be displayed pixel for which the display still requires data. The target display position can be represented as the tuple (x_{target}, y_{target}) where the x_{target} parameter represents the displacement of the target display position pixel in a horizontal direction from a predetermined origin (e.g., the top left hand corner of the display area), and the y_{target} parameter represents the target display position pixel in a vertical displacement from the origin.

The target display position can be determined, for example, based upon several parameters including the current display position, the display resolution of the display, and the amount of display data already made available to the display but has not yet been displayed. For example, according to an embodiment in which the display displays pixels on a screen in a left-right top-down raster scan pattern, the target display position can be determined by starting at the current display position and counting a number of pixels equal to the number of pixels that are already made available to the display. x_{target}=(x_{curr}+available_pixels) mod horizontal_resolution, and y_{target}=y_{curr}+(x_{curr}+available_pixels) div horizontal_resolution. available_pixels represents the number of pixels that have already been made available to the display but not as yet been displayed, and horizontal_resolution is the horizontal resolution of the display in pixels.

In step 406, the time interval to display the pixel at the target display position is determined. The time interval can be determined based on the display clock frequency of the display and the number of pixels to be displayed from the current display position to the target display position. The display clock, for example, can represent the time to display respective pixels. The determination of the time interval also includes including one or more vertical blanking intervals if the current display position and target display position have different vertical coordinates.

The relative ordering of the displays can be based on the time interval determined for the respective devices. For example, the display with the shortest time interval can be assigned the highest priority. Method 400, as described above, is one method of determining the relative order of priority of the displays. Other methods of determining the relative priority ordering of displays based upon how long each respective display can properly operate without requiring new display data are possible and are contemplated within the scope of the present invention. For example, according to an embodiment, a time interval can be determined based upon the available pixels and the display clock of the display, by determining the time to display all the available pixels.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for arbitrating display data requests for a plurality of displays configured for coupling to a controller, comprising:
providing display data to a display in the plurality of displays based upon a relative priority of the display amongst the plurality of displays.

2. The method of claim 1, further comprising:
dynamically determining the relative priority for the display based upon when display data is needed by the display.

3. The method of claim 2, wherein the dynamically determining comprises:
identifying a current display position in the display;
identifying a target display position in the display; and
determining a time interval based upon the target display position and the current display position.

4. The method of claim 3, wherein identifying the target display position comprises:
determining already retrieved pixels for display in the display; and
selecting the target display position based upon the already retrieved pixels.

5. The method of claim 3, wherein the determining the time interval comprises:
determining a pixel period of the display;
determining a number of pixels to display between the target display position and the current display position; and
calculating the time interval based upon the number of pixels to display and the pixel period.

6. The method of claim 5, wherein the pixel period is based upon a display frequency of the display.

7. The method of claim 6, wherein the display frequency is dynamically determined.

8. The method of claim 2, wherein the providing comprises:
determining a corresponding source pixel for additional display data; and
retrieving one or more pixels based upon the corresponding source pixel to a local memory.

9. The method of claim 8, wherein the determining a corresponding source pixel comprises:
scaling a position in the display of the additional display data to determine the source pixel.

10. The method of claim 8, wherein the scaling is based upon one or more of a scale ratio and a position of a scaled image within a display image.

11. The method of claim 8, wherein the retrieving comprises:
determining a number of pixels to retrieve; and
accessing a memory to retrieve the number of pixels.

12. The method of claim 11, wherein the number of pixels to retrieve is based upon one or more factors including a depth of the local memory.

13. The method of claim 11, wherein the number of pixels to retrieve is based upon one or more factors including a display frequency of the first display.

14. The method of claim 8, further comprising:
tagging the one or more retrieved pixels.

15. The method of claim 14, wherein a tag identifying the corresponding source pixel is used for the tagging.

16. A graphics controller, comprising:
a plurality of display interfaces respectively configured to couple one or more of a plurality of displays;
a display output arbitration module coupled to the one or more display interfaces and configured for:
providing display data to a display in the plurality of displays based upon a relative priority of the display amongst the plurality of displays.

17. The graphics controller of claim 16, wherein the display output arbitration module further comprises:
dynamically determining the relative priority for the display based upon when display data is needed by the display.

18. The graphics controller of claim 16, further comprising:
a timing controller coupled to the display output arbitration module and configured to determine a display pixel for respective ones of the plurality of displays.

19. The graphics controller of claim 18, further comprising:
a scaler coupled to the timing controller and configured to determine a source pixel based upon the display pixel.

20. The graphics controller of claim 18, wherein the display output arbitration module is further configured for:
identifying a current display position in the display;
identifying a target display position in the display; and
determining a time interval based upon the target display position and the current display position.

21. A computer readable storage medium storing instructions wherein said instructions when executed are adapted to arbitrate display data requests for a plurality of displays coupled to a controller by comprising:
providing display data to a display in the plurality of displays based upon a relative priority of the display amongst the plurality of displays.
